(19) United States
(12) Patent Application Publication
(10) Pub. No.: US 2007/0234603 A1
(43) Pub. Date: Oct. 11, 2007

(54) RV on-road alert system and method

(76) Inventors: Cathy R. Delancy, Slidell, LA (US); Sean M. Delancy, Avon, CO (US); Jason M. Delancy, Slidell, LA (US)

Correspondence Address: Ward & Olivo, 382 Springfield Avenue, Summit, NJ, 07901, US

(21) Appl. No.: 11/402,232

(22) Filed: Apr. 11, 2006

(51) Int. Cl. B42F 17/34

(52) U.S. Cl. 40/378

(57) ABSTRACT

A system and method for communicating dangers by a vehicle occupant to a third party vehicle occupant comprising a RV on-road alert guide having a plurality of pages bound with a spiral bound and printed with alert messages. The pages exhibiting tabs extending from each page printed with reference information related to the page. In utilizing the system the vehicle occupant identifies a vehicle which can cause a potential danger, chooses an appropriate alert message page from the RV on-road alert guide using the tabs, and displays the appropriate alert message by holding the RV on-road alert guide against a window of the occupant's vehicle to the third party vehicle occupant.

### FIELD OF THE INVENTION

The present invention generally relates to the field of on-road warning or notification systems and methods, and more specifically, to a system and method for communicating hazardous roadside conditions or other dangers through the use of a RV on-road alert guide wherein a vehicle occupant can communicate to a third party vehicle occupant within a certain proximity to the vehicle occupant using the RV on-road alert guide. The RV on-road alert guide comprising a plurality of pages bounded within a spiral bound and printed with alert messages, wherein the plurality of pages comprise extending tabs or other protruding portions for readily accessing desired pages contained within the RV on-road alert guide.

### BACKGROUND OF THE INVENTION

In its primary embodiment, disclosed is a RV on-road warning or notification system and method for communicating to a third party vehicle occupant. In utilizing the system, the one vehicle occupant identifies another vehicle which the vehicle occupant wishes to communicate with and chooses an appropriate alert message page from the RV on-road alert guide. In its simplest form, by accessing the tabs the vehicle occupant is able to display the appropriate alert message by holding the RV on-road alert guide against a window of the occupant's vehicle.

There exists a need in the art for such a system as road users often encounter dangerous road hazards on the road. Such road hazards can easily be avoided if they are simply communicated to other drivers or vehicle occupants on the road. Primarily, danger to road users exist due to potentially hazardous roadways and surrounding terrain conditions, but it is often the case that hazardous situations are the result of improperly maintained vehicles within a certain proximity to other road users. In many cases the cause of these hazardous conditions are the result of a vehicle occupant's failure to quickly notice and rectify a problem that ultimately results in causing a hazardous condition for other road users. More importantly, the vehicle occupants are often not aware that something is wrong with their vehicles. For example, an occupant of a recreational vehicle may not readily notice that a tire is low on air which could lead to a tire malfunction or that an exterior awning mounted to the rear of a recreational vehicle is not properly retracted and secured resulting in potential damage to the recreational vehicle or a potential hazard to other vehicles. However, in many cases these deficiencies or problems are often readily apparent to occupants of other vehicles utilizing the roadway. While it is often most important for other drivers within a proximity to a hazardous vehicle or other hazardous condition to drive “defensively” and make a conscious effort to avoid any risks while driving, as a courtesy, the other drivers on the roadway try to communicate potential dangers to the driver of the endangering vehicle by flashing lights, honking the vehicle horn, or by pulling next to the vehicle and trying to get the driver's attention. However, this is not very effective and it can make the situation even more dangerous since the driver's attention is no longer directed to the road. Furthermore, even if a party is able to grab the attention of the driver of the hazardous vehicle, it is often very difficult to communicate with the driver and direct the driver to the hazardous condition that needs to be rectified.

Although communication between traveling vehicles is often difficult and can create hazardous situations, communication between a traveling vehicle and a stationary vehicle or individual can be difficult and hazardous as well. For example, a disabled vehicle on the side of a roadway often requires the assistance of traveling passing vehicles in order to obtain emergency assistance. Again, such communication is often difficult and more importantly most passing vehicles are often reluctant to assist without knowing the exact type of assistance required.

Thus, various devices have been proposed for displaying warning messages to drivers and other vehicle occupants. These display devices are often mounted inside the vehicle in a manner so that they are visible to occupants of other vehicles and positioned so that they are readily apparent to occupants of other vehicles. In these systems, the warning signs are pre-printed with warning messages and are integrated within a display device. Depending on the desired message to be displayed, different messages can be provided and can be changed depending upon the situation. Although these systems can be effective in communicating messages, such devices are not useful in emergency situations since they require the immediate attention of drivers. In addition, in order to change the message by a driver, he must devote an excessive amount of time for completing the task. Specifically, in order to change the message to be displayed, the correct message has to be found and then inserted in or mounted on the display device (depending on the configuration of the display device). Additionally, such display devices can impair the driver's visibility since they are mounted inside the vehicle within a driver's sightline and in close proximity to the driver. Typically, this is required to insure that the driver has complete access to the system.

Automated signs are also common in the art for alerting occupants of other vehicles of dangerous conditions. Typically, these devices comprise a display unit, electronic memory, and some type of user interface. Such signs can be mounted away from the driver inside or outside the vehicle and can be controlled by the driver or other occupant with the user interface. The vehicle occupant can scroll and select pre-stored warning messages using the interface or enter new messages that apply to the situation. Although the automated sign is very effective and technologically advanced, it is difficult to market due to high unit price and high installation costs.

For example, several of these types of the aforementioned systems are known in the art. For example, U.S. Pat. No. 3,237,330 to Dinstbir discloses a warning device for use within a vehicle to remind the driver to turn the headlights on. This invention is designed to encourage drivers to utilize headlights during driving and more particularly during daytime hours to improve the overall safety of driving conditions and comply with local traffic laws. While the objective of this invention is to provide an economical device that can be offered as a promotional or free item, this invention is merely limited to an internal reminder system and would not prove useful for notifying drivers or occupants of other vehicles that help is required or that a hazardous situation exists.

U.S. Pat. No. 3,800,430 to Samra provides a visual signal device for vehicles. The device comprises an opening for inserting window panels therein. The device can be further illuminated and controlled from the driver position. However, this device fails to provide a simple and cost-efficient display mechanism as the invention requires installation which can be damaging to the vehicle and costly to install.

In another example, U.S. Pat. No. 3,810,092 to Tucker discloses a warning and distress signal device for a disabled vehicle. The device is designed to adhere to the roof structure of the vehicle and further comprises distress signals. However, this device is merely directed to an apparatus for notifying passing vehicles from a stationery vehicle and not for notifying other vehicles from a traveling vehicle. Tucker also fails to disclose an efficient and simple RV on-road alert mechanism comprising readily interchangeable tabs for displaying the appropriate alert message by holding the RV on-road alert guide against a window of the occupant's vehicle.

U.S. Pat. No. 3,924,344 to Davis also discloses a device capable of being mounted on a horizontal surface of a motor vehicle for exhibiting interchangeable emergency signs. However, Davis fails to disclose a device for communicating hazardous roadway conditions and merely identifies the condition of a stationary roadside vehicle rather than an efficient mechanism for communicating various potentially hazardous conditions to other vehicles.

As another example, U.S. Pat. No. 4,328,481 to Sexton provides an apparatus for visually displaying illuminated messages. Sexton discloses a complex illuminated device designed to act as a visual stimulus for grabbing the attention of a viewer. Various patterns of light emission are described and the utilization of various opaque and light transmission portions are disclosed for providing an energized display mechanism. While this device requires elaborate construction and special installation, the system of Sexton fails to provide a cost-effective and efficient mechanism for alerting occupants of vehicles of various road conditions and hazards.

U.S. Pat. No. 4,922,223 to Prevot provides an emergency identifying apparatus for motor vehicles for displaying highly visible messages to approaching motorists. Prevot is directed to an off-road stationary system for disabled and inoperable vehicles and is not directed to an efficient messaging service for communication between vehicles.

U.S. Pat. No. 5,058,523 to Mikkonen et al. provides a device for preventing inadvertent headlight illumination to the driver. This narrow invention comprises a cavity formed in a vehicle door panel for displaying a device to other vehicles. While useful in notifying drivers of improper headlight illumination this device fails to provide sufficient communication to occupants of other vehicles in various situations. Furthermore, this device requires an elaborate installation mechanism for proper use.

Another example includes, U.S. Pat. No. 5,363,092 to Starchevich discloses a portable signaling device. Starchevich comprises a housing having a first face and a second face, the housing being provided with a first opening in the first face and a second opening in the second face wherein the first opening is smaller than the second opening. The device further includes a lamp mounted to the housing for motion between a first position in which the lamp is oriented towards the first opening and a second position in which the lamp is oriented towards an interior of the housing. The elaborate device of Starchevich requires an electronic power supply and specific manufactured components that result in high cost of production compared to the device disclosed herein.

U.S. Pat. No. 5,502,909 to Rabkin provides a sign for alerting passing motorists of the operational conditions of a vehicle. Similar to the device disclosed in U.S. Pat. No. 4,922,223 to Prevot, Rabkin is directed to an off-road stationary system for disabled and inoperable vehicles and is not directed to an efficient messaging service for communication between vehicles.

U.S. Pat. No. 5,918,397 to Elmer discloses a display for use above the roof of a vehicle. Elmer provides a rigid elongated and enclosed advertising system for storing a series of advertising messages. Elmer further discloses a system for illuminating the rigid device. Similar to several of the aforementioned systems, Elmer is directed to an elaborate information system rather than an efficient and cost-effective alert guide as disclosed herein.

In addition, U.S. Pat. No. 6,273,597 to Rolack discloses a roadside warning sign system. The system comprises a support member integrated with a rectangular configuration for displaying a series of informational insertions. The system further includes an illumination means and a cigarette charger for sourcing power to the illumination means. However, this device fails to provide a simple and cost-efficient display mechanism as the invention requires installation which can be damaging to the vehicle and costly to install.

U.S. Pat. No. 6,446,375 to Davis provides a transparent envelope which attaches to an automobile window via suction cups. A selected message can be displayed in the envelope through the envelope's transparent front side when it is attached to the inside of an automobile window, or a selected message can be displayed through the envelope's transparent back side while the envelope is attached to the outside of an automobile window by the same means. Davis further discloses the use of indentations at the top of the envelope for removal of the message sheets. However, Davis requires elaborate construction and fails to disclose a simple and cost effective system for displaying informational messages to vehicles.

U.S. Pat. No. 6,688,027 to Fink provides a message board which displays one or more messages about the vehicle for attracting help. Specifically, Fink discloses a first face of the message board adapted to receive one or more message cards. These message cards are preprinted containing common messages such as “OUT OF GAS”, “FLAT TIRE”, etc. In addition, an erasable marker may be used to write a short message on a blank message card which may be displayed alone or in combination with one or more preprinted cards. The message board may be reversed and the second face is adapted to receive a longer, hand written message. Fink further discloses an attachment mechanism comprising suction cups and a flashing strobe type signal lamp for calling attention to the message board and a stopped vehicle. However, Fink fails to disclose a device for communicating hazardous roadway conditions and merely identifies the condition of a stationary roadside vehicle rather than an efficient mechanism for communicating various conditions to other vehicles.

In light of complex systems known in the art, it is clear that what is needed is a system and method for communicating dangers to potentially endangered vehicle occupants without the limitations of the foregoing devices and systems.

### SUMMARY OF THE INVENTION

One object of the present invention is to provide a RV on-road alert system and method for displaying RV on-road alerts to potentially endangered vehicle occupants.

Another object of the present invention is to provide a simple and easy to use RV on-road alert guide for displaying RV on-road alerts to potentially endangering vehicle occupants.

Another object of the present invention is to make the occupant of other vehicles aware of possible hazardous or costly situations.

In addition, it is an object of the present invention to provide a device for alerting occupants of other vehicles that requires a relatively low cost of manufacture.

A further object of the present invention is to help vehicle occupants communicate problems on the road with minimal effort and in-turn help prevent hazardous conditions.

In one embodiment of the present invention a system is provided for communicating dangers by a vehicle occupant to a third party vehicle occupant or series of third party vehicle occupants through the use of a RV on-road alert system, the system comprising a RV on-road alert guide having a plurality of pages bound with a spiral bound and printed with alert messages. In addition, the system includes a plurality of extending tabs for quickly and efficiently locating the pages bound within the spiral notebook. In one example, a vehicle occupant may select an appropriate alert message page from the RV on-road alert guide using the extending tabs in the event that the vehicle occupant identifies a vehicle which can cause a potential danger. With the RV on-road guide in hand the vehicle occupant displays the appropriate alert message to the third party vehicle occupant by holding the RV on-road alert guide against a window of the occupant's vehicle or positions the RV on-road alert guide in some other location that is readily visible to the offending vehicle. The messages displayed may include any series of informative messages that could notify the third party vehicle occupant of various hazardous or potentially conditions. For example, the pre-printed messages common for passenger vehicles may include “EMERGENCY”, “VEHICLE IS LEAKING FLUID”, “FLAT TIRE”, or “TIRE IS LOW ON AIR”. In addition to these listed messages specific messages for other vehicles or activities may be developed. For example, in addition to the messages listed above, the messages common for use by recreational vehicles may include, “COMPARTMENT OPEN”, “OPEN WINDOW”, “ANTENNA UP”, “VENT OPEN”, “DOOR AJAR”, “TAIL LIGHT OUT”, “HAND RAIL OUT”, “GAS CAP OPEN”, “CHECK SAFETY CHAIN”, “BIKES LOOSE”, and “CANOPY OPEN”. Furthermore, the messages for use by occupants of water-based vehicles, in addition to several of the messages above, may include “NO WAKE ZONE”, “HATCH OPEN”, “ANTENNA BROKEN”, “BUMBER LOOSE”, “ANCHOR DRAGGING”, “ANCHOR LOOSE”, “RADAR LOOSE”, and “CHECK PROPELLER”.

### BRIEF DESCRIPTION OF THE DRAWINGS

A further understanding of the present invention can be obtained by reference to a preferred embodiment as set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the specific methods and instrumentalities disclosed.

For a more complete understanding of the present invention, reference is now made to the following drawings in which:

FIG. 1 illustrates the RV on-road alert guide in accordance with the present invention.

FIG. 2 illustrates the RV on-road alert guide comprising tabs in accordance with the present invention.

FIG. 3 is a flowchart illustrating a method of using the RV on-road alert guide in accordance with the present invention.

FIG. 4 illustrates the RV on-road alert guide displayed through a window of a vehicle in accordance with the present invention.

### DETAILED DESCRIPTION OF THE PREFERRED EMBODIMENTS

A detailed illustrative embodiment of the present invention is disclosed herein. However, techniques, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for the purposes of disclosure and to provide a basis for the claims herein, which define the scope of the present invention. The following presents a detailed description of a preferred embodiment (as well as some alternative embodiments) of the present invention.

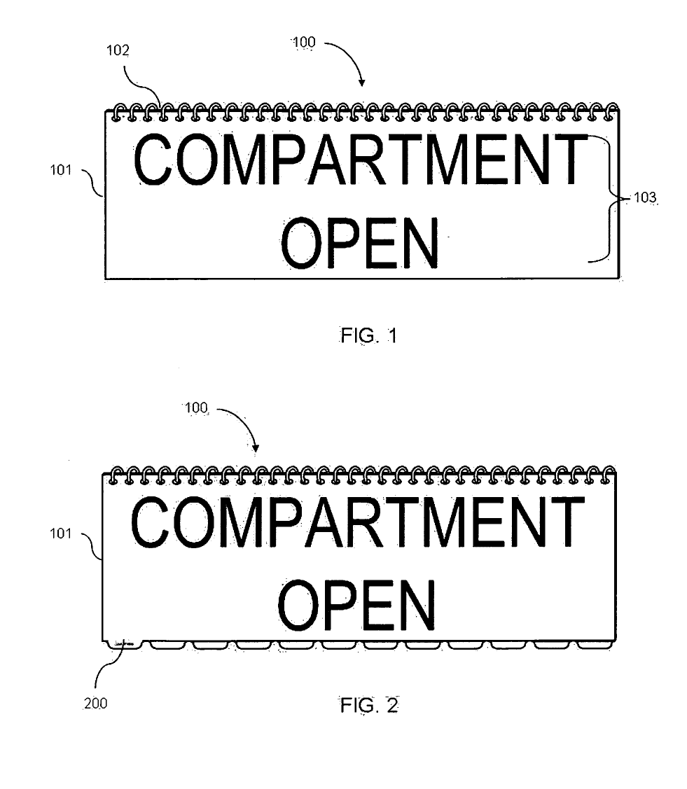

Referring to the drawings wherein like numerals indicate like elements throughout, there is shown in FIG. 1 a RV on-road alert guide 100 for communicating dangers by a vehicle occupant to a third party vehicle occupant. The vehicle occupant, according to the present invention, can include the driver of the vehicle or any passenger of the vehicle. The RV on-road alert guide 100 comprises plurality of pages 101, wherein the alert guide is bounden using a spiral bound 102; however, it is contemplated that any other bounding systems common in the art can be used such as those conventionally used in various book related apparatuses. The spiral bound 102 allows for fast and easy flip and access of the pages. The spiral bound 102 further allows the pages to rotate and be positioned behind the desired page. The RV on-road alert guide 100 is preferably of a large size providing good visibility through a vehicle window. However, the RV on-road alert guide 100 is also of constructed of sufficient size to be easily stored. For example, in the preferred embodiment of the present invention, the RV on-road alert guide pages 101 are preferably constructed of a wide rectangle configuration measuring approximately twelve inches in length and four inches in height. Text is imprinted on RV on-road alert guide pages 101 in such a nature to offer centered messages. Sufficient header portions and footer portions are provided to allow for a clear message to be conveyed that is legible at certain distances. For example, in the preferred embodiment wherein an apparatus comprising twelve inches in length and four inches in height RV on-road alert guide pages 101, text of two centered rows of one and one half inches in height for each row and a three eighths inch header and footer and one quarter inch of vertical separation between the two rows of text is used. Such configuration allows the RV on-road alert guide 100 to be conveniently stored behind a visor or inside a door compartment, both typically of a shallow and long configuration.

Each page of RV on-road alert guide page 101 is pre-printed either on one side or both sides with an alert message 103 of a type which identifies potentially hazards or dangerous vehicle conditions to occupants of other vehicles within a proximity to the vehicle occupant using the RV on-road alert guide 101. The RV on-road alert guide 100 can be customized with messages 103 which apply to a particular vehicle types such as, but not limited to a car, recreational vehicle, truck, motorcycle, bus, trailer, or the like, including any combinations thereof. For example, recreational vehicle directed RV on-road alert guide may comprise messages including, but not limited to, “COMPARTMENT OPEN”, “ANTENNA UP”, “WINDOW OPEN”, “VENT OPEN”, “DOOR AJAR”, “TAIL LIGHT MALFUNCTION”, “HEADLIGHT MALFUNTION”, “HAND RAIL OUT”, “GAS CAP OPEN”, “SAFETY CHAIN INOPERABLE”, “BICYCLES LOOSE”, “BRAKE LIGHT OUT”, “CANOPY OPEN”, “CANOPY NOT SECURED”, “LOW TIRE”, or the like.

For better durability, the RV on-road alert guide 100 can be made of a durable light-weight material such as plastic or each of the alert pages can be laminated to keep the RV on-road alert guide 100 from damage due to extensive use, damage from weather conditions, or other damage that may be typical during use. Although a plastic composition is the preferred material of manufacture, it is readily apparent to those of skill in the art that other materials may be used including heavy-paper, woven fibers, metals, or any other material or composite common in the art.

FIG. 2 illustrates RV on-road alert guide 100 having tabs 200 extending from the bottom portion of each alert page 101. Each tab 200 can be pre-printed with the alert message of the corresponding alert page 101 or can be printed with a shorter version of the message or other common identifier to allow for easy reference. As such, the vehicle occupant can easily look at the protruding tabs 200 and quickly identify the desired messages. Additionally, the tabs can be grabbed by the vehicle occupant and the page can be flipped to the front of the RV on-road alert guide 100 for display. Of course, it is understood by one skilled in the art that any other tab configuration different from the one illustrated in FIG. 2 can be used.

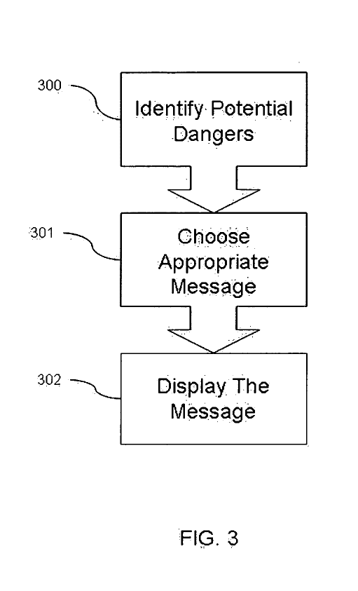

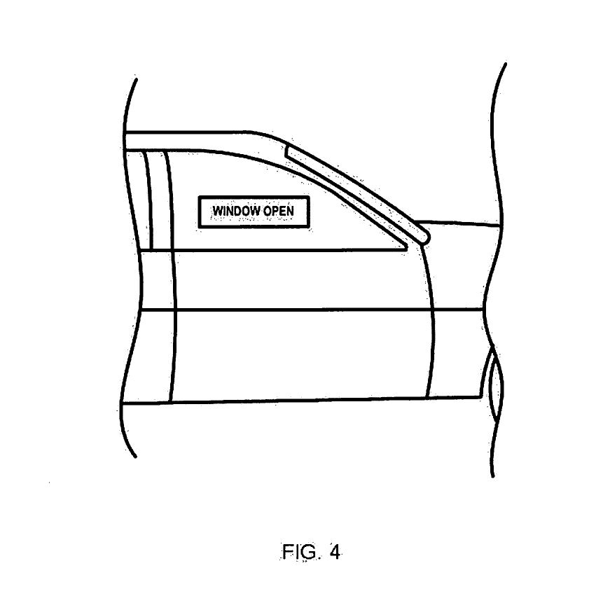

FIG. 3 is a flowchart illustrating a method of using RV on-road alert guide 100. Initially, a vehicle occupant using the present invention identifies a third party vehicle which can cause a potential danger on the road in step 300. When driving down the road, a vehicle occupant may see possible dangers which could be caused by a low tire, an unsecured canopy, or loose and improperly secured bicycles attached by a certain mechanism on the rear portion of a recreational vehicle. Depending on the severity of the hazard, it may be readily apparent to a vehicle occupant using the RV on-road alert guide that such a hazard may cause an accident or damage to other vehicles, damage to the vehicle in question, or damage to the product being carried by the vehicle in question (e.g., the unsecured bicycles).

In one example, a vehicle occupant using the RV on-road alert guide may be driving behind a recreational vehicle and notice that one of the recreational vehicle's windows is open. The opposite air friction during driving may cause the window to rip off the recreational vehicle and possibly damage vehicles traveling behind. Thus, in this example the vehicle occupant would use the RV on-road alert guide 100 to warn the recreational vehicle occupant, such as the driver or any other passenger, that a window on the vehicle is open. The vehicle occupant will obtain the RV on-road alert guide 100 from its storage location and choose an appropriate message in step 301. As described above, the vehicle occupant can look at the tabs and find the appropriate message, in this example it would be “WINDOW OPEN”. The vehicle occupant will use the tab to turn over the page such as it would appear at the front of the RV on-road alert guide 100.

Next, the vehicle occupant will display the appropriate alert message in step 302 by holding RV on-road alert guide 100 against the vehicle window as illustrated in FIG. 4. The vehicle driver may pull next to the recreational vehicle to allow the occupant of the recreational vehicle to easily read the displayed message. Advantageously, the present invention can be used by any individual present in the vehicle. Thus, if the driver of the vehicle is unable to pull within a close proximity to the recreational vehicle, a passenger in the vehicle can display the RV on-road alert guide 100 through other windows in the vehicle as depicted in FIG. 4.

From the foregoing description of the preferred embodiments, which embodiments have been set forth in considerable detail for the purpose of making a complete disclosure of the present invention, it can be seen that the present invention comprises a system and method for communicating dangers by a vehicle occupant to a third party vehicle occupant via a RV on-road alert guide. It will be appreciated by those skilled in the art that changes could be made to the embodiment described above without departing from the broad inventive concept thereof. It is understood, therefore, that this invention is not limited to the particular embodiment disclosed, but it is intended to cover all modifications that are within the scope and spirit of the invention as defined by the appended claims.

What is claimed is:

1. A system for communicating dangers by a vehicle occupant to a third party vehicle occupant via a RV on-road alert guide, said system comprising:
a RV on-road alert guide having a plurality of pages bounded with a spiral bound and printed with alert messages;
extending tabs;
wherein said vehicle occupant identifies a vehicle which can cause a potential danger;
wherein said vehicle occupant chooses an appropriate alert message page from said RV on-road alert guide using said tabs; and
wherein said vehicle occupant displays said appropriate alert message by holding said RV on-road alert guide against a window of said occupant's vehicle to said third party vehicle occupant.

2. A system according to claim 1 wherein said tabs are printed with reference information related to said alert messages.

3. A system according to claim 1 wherein said RV on-road alert guide comprises a wide rectangle.

4. A system according to claim 1 wherein said RV on-road alert guide measures 12 by 4 inches.

5. A system according to claim 1 wherein said RV on-road alert guide is stored behind a visor or inside a door compartment.

6. A system according to claim 1 wherein said alert messages comprise at least one text portion selected from a group consisting of “compartment open”, “antenna up”, “window open”, “vent open”, “door ajar”, “tail light out”, “hand rail out”, “gas cap open”, “safety chain”, “bikes loose”, “brake light out”, “canopy open”, and “low tire”.

7. A system according to claim 1 wherein said RV on-road alert guide is composed of plastic.

8. A system according to claim 1 wherein said RV on-road alert guide is laminated.

9. A system according to claim 1 wherein said tabs extend from the bottom portion of each of said plurality of pages.

10. A method for communicating dangers by a vehicle occupant to a third party vehicle occupant via a RV on-road alert guide, said method comprising the steps of:
providing a RV on-road alert guide having a plurality of pages bounded with a spiral bound and printed with alert messages, and wherein said plurality of pages comprise extending tabs;
identifying a vehicle which can cause a potential danger;
choosing an appropriate alert message page from said RV on-road alert guide using said tabs; and
displaying said appropriate alert message by holding said RV on-road alert guide against a window of said occupant's vehicle to said third party vehicle occupant.

11. A system for communicating dangers by a vehicle occupant to a third party vehicle occupant via a RV on-road alert guide, said system comprising:
a RV on-road alert guide having a plurality of bound pages;
printed alert messages displayed by said bound pages; and
protrusions extending from said bound pages.

12. A system according to claim 11 wherein said protrusions are printed with reference information related to said alert messages.

13. A system according to claim 11 wherein said RV on-road alert guide is composed of plastic.

14. A system according to claim 11 wherein said RV on-road alert guide is composed of laminated material.

15. A system according to claim 11 wherein said RV on-road alert guide is composed of metal.

16. A system according to claim 11 wherein said RV on-road alert guide is composed of woven material.

17. A system according to claim 11 wherein said alert messages comprise at least one text portion selected from a group consisting of “compartment open”, “antenna up”, “window open”, “vent open”, “door ajar”, “tail light out”, “hand rail out”, “gas cap open”, “safety chain”, “bikes loose”, “brake light out”, “canopy open”, and “low tire”.
